(19) United States
(12) Patent Application Publication
(10) Pub. No.: US 2025/0038571 A1
(43) Pub. Date: Jan. 30, 2025

(54) DATA-ANALYSIS-BASED CONTROL OPTIMIZATION OF SHADOW-EFFECT ENERGY GENERATION

(71) Applicant: INTERNATIONAL BUSINESS MACHINES CORPORATION, Armonk, NY (US)

(72) Inventors: Sarbajit K. RAKSHIT, Kolkata (IN); Manikandan PADMANABAN, Chennai (IN); Jagabondhu HAZRA, Bangalore (IN)

(21) Appl. No.: 18/358,171

(22) Filed: Jul. 25, 2023

(51) Int. Cl. H02J 50/00; G08G 1/01; H02J 13/00

(52) U.S. Cl. CPC H02J 50/001; G08G 1/01; H02J 13/00002; H02S 20/10; H02S 20/21

(57) ABSTRACT

Data-analysis-based processes for optimizing road-based, shadow-effect energy generation are provided. The processes include obtaining a data-analysis-based control to facilitate energy harvesting using road-based, shadow-effect energy generation. The data-analysis-based control determines, for multiple road segments of a road, a respective illumination-to-shadow contrast value, and based on the respective illumination-to-shadow contrast values, identifies one or more road segments of the multiple road segments for shadow-effect energy generation. In addition, the data-analysis-based control initiates install of a shadow-effect energy generator in a road segment of the identified one or more road segments to facilitate energy harvesting from the road segment.

### BACKGROUND

This disclosure relates generally to facilitating energy harvesting, and in particular, to enhancing energy harvesting using shadow-effect energy generation.

The energy sector accounts for a significant portion of total greenhouse gas emissions globally. Many countries are aligning their support towards clean energy, including solar energy generation. With increasing focus on renewable, sustainable and clean energy, energy systems are expected to continue undergoing transformations to meet the growing demands for clean energy.

A solar array, or solar cell array, can include one or more solar cell panels, or photovoltaic panels, which are an assembly of photovoltaic solar cells that capture sunlight as a source of radiant energy that is converted into electricity in the form of direct current (DC) electricity. Solar cells can be made of a variety of technologies. For instance, solar cells can be made of crystalline silicon wafers, or be based on thin-film silicon technologies. In other implementations, solar cells can be based on amorphous silicon. Other solar cell technologies are also possible in the art. Solar cell arrays can be used in a variety of applications, including road infrastructure-based, solar array applications.

### SUMMARY

Certain shortcomings of the prior art are overcome, and additional advantages are provided herein through the provision of a computer-implemented method of facilitating energy harvesting. The computer-implemented method includes obtaining a data-analysis-based control to facilitate energy harvesting using road-based, shadow-effect energy generation. The data-analysis-based control includes determining, for multiple road segments of a road, a respective illumination-to-shadow contrast value, and based on the respective illumination-to-shadow values, identifying one or more road segments of the multiple road segments for shadow-effect energy generation. Further, the data-analysis-based control includes initiating install of a shadow-effect energy generator in a road segment of the identified one or more road segments to facilitate energy harvesting from the road segment.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a computer program product with a shadow-effect energy harvest control module, in accordance with one or more aspects of the present disclosure;

FIG. 3 depicts one embodiment of a shadow-effect energy harvest control workflow, in accordance with one or more aspects of the present disclosure;

FIG. 4 is a schematic illustration of shadow-effect energy generation used or to be included in one or more aspects of the present disclosure;

FIG. 5 depicts another embodiment of shadow-effect energy harvest control workflow, in accordance with one or more aspects of the present disclosure;

FIG. 6 is a further example of a computing environment to include and/or use one or more aspects of the present disclosure;

FIG. 7A depicts a further embodiment of a shadow-effect energy harvest control workflow, in accordance with one or more aspects of the present disclosure;

FIG. 7B graphically illustrates energy harvest potential using a shadow-effect energy generator, in accordance with one or more aspects of the present disclosure;

FIG. 8 is a schematic illustrating road-based, shadow-effect energy generation, in accordance with one or more aspects of the present disclosure; and

FIG. 9 is a further embodiment of a shadow-effect energy harvest control workflow, in accordance with one or more aspects of the present disclosure.

### DETAILED DESCRIPTION

The accompanying figures, which are incorporated in and form a part of this specification, further illustrate the present disclosure and, together with this detailed description of the disclosure, serve to explain aspects of the present disclosure. Note in this regard that descriptions of well-known systems, devices, processing techniques, etc., are omitted so as to not unnecessarily obscure the disclosure in detail. It should be understood, however, that the detailed description and this specific example(s), while indicating aspects of the disclosure, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative control embodiment can be implemented in software, hardware, or a combination thereof.

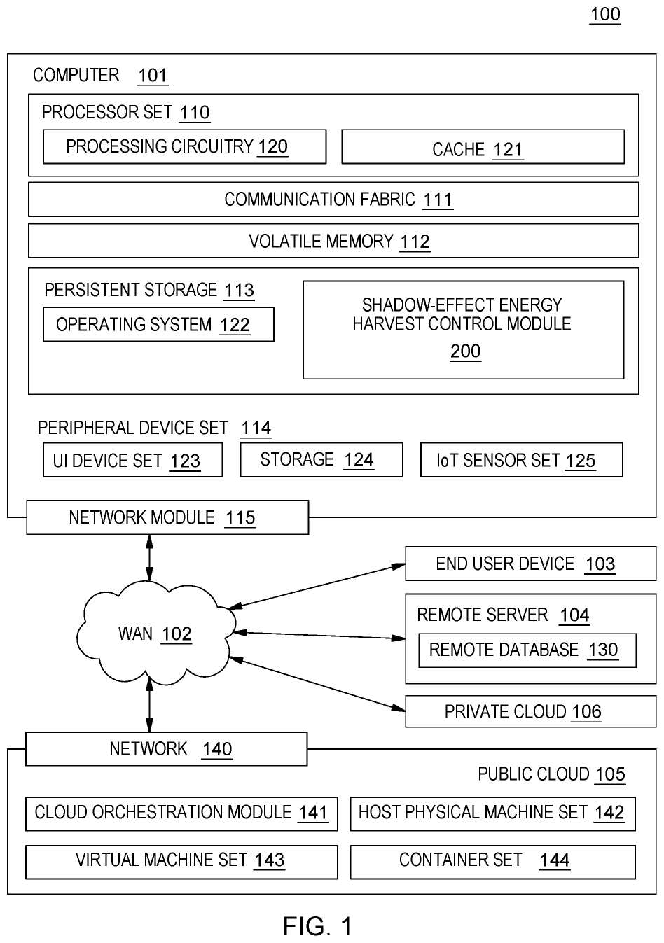

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and shadow-effect energy harvest control module 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one processor or multiple processors, and/or any other type of environment and/or configuration, etc., that is capable of executing a process (or multiple processes) that, e.g., perform shadow-effect energy harvest control processing, such as disclosed herein. Aspects of the present disclosure are not limited to a particular architecture or environment.

Prior to further describing detailed embodiments of the present disclosure, an example of a computing environment to include and/or use one or more aspects of the present disclosure is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as shadow-effect energy harvest control module block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

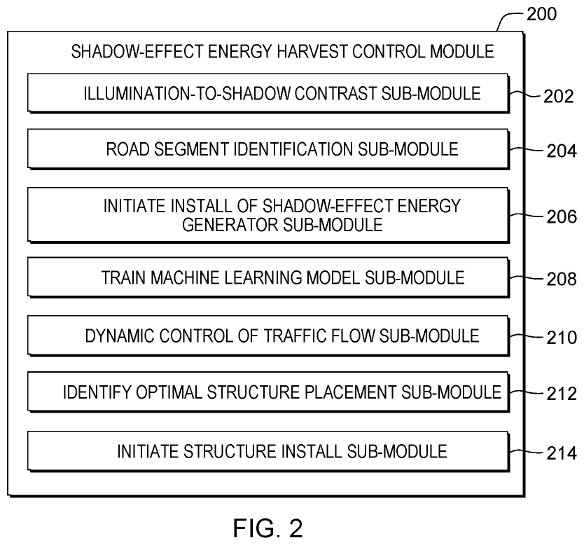

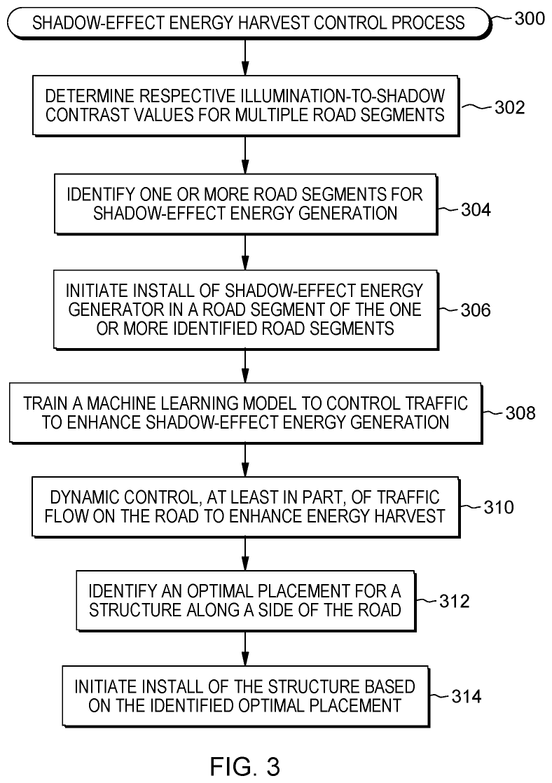

By way of example, one or more embodiments of a shadow-effect energy harvest control module and process are described initially with reference to FIGS. 2-3. FIG. 2 depicts one embodiment of shadow-effect energy harvest control module 200 that includes code or instructions to perform shadow-effect energy harvest control processing, in accordance with one or more aspects of the present disclosure, and FIG. 3 depicts one embodiment of a shadow-effect energy harvest control process, in accordance with one or more aspects of the present disclosure.

Referring to FIGS. 1-2, shadow-effect energy harvest control module 200 includes, in one example, various sub-modules used to perform processing, in accordance with one or more aspects of the present disclosure. The sub-modules are, e.g., computer-readable program code (e.g., instructions) and computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101; processors, such as a processor of processor set 110; and/or processing circuitry, such as processing circuitry of processor set 110, etc.

As noted, FIG. 2 depicts one embodiment of a shadow-effect energy harvest control module 200 which, in one or more embodiments, includes, or provides, a control, or data-analysis-based control, to facilitate energy harvesting using road-based, shadow-effect energy generation. In the embodiment of FIG. 2, example sub-modules of shadow-effect energy harvest control module 200 include an illumination-to-shadow contrast sub-module 202 to determine, for multiple road segments of a road, a respective illumination-to-shadow contrast value, and a road segment identification sub-module 204 to identify, based on the respective illumination-to-shadow values, one or more road segments of the multiple road segments for shadow-effect energy generation. Further, the shadow-effect energy harvest control module includes an initiate install of shadow-effect energy generator sub-module 206 to initiate install of a shadow-effect energy generator in a road segment of the identified one or more road segments to facilitate energy harvesting from the road segment.

In one or more embodiments, shadow-effect energy harvest control module 200 further includes a train machine learning model sub-module 208 to train a machine learning model to control traffic, at least in part, on the road to enhance the road-based, shadow-effect energy generation, and a dynamic control of traffic flow sub-module 210 to dynamically control, at least in part, the traffic on the road using the trained machine learning model, to increase energy generation from the road-based, shadow-effect energy generation.

In one or more further embodiments, shadow-effect energy harvest control module 200 includes an identify optimal structure placement sub-module 212 to facilitate identifying optimal placement of a structure along a side of a road to enhance energy harvesting using the road-based, shadow-effect energy generation, and an initiate structure install sub-module 214 to initiate install of the structure based on the identified optimal placement for the structure along the side of the road to enhance energy harvesting using the road-based, shadow-effect energy generation 214. In one or more embodiments, the structure is any roadside structure which casts a shadow contour onto the road, and can include, for instance, a pole (e.g., smart pole, streetlight pole, etc.), a sign or billboard, a tree, etc. In one embodiment, the structure is, or includes, a streetlight, and the identifying optimizes position of the streetlight relative to the road-based, shadow-effect energy generation to optimize energy harvesting from the road-based, shadow-effect energy generation at night, when the streetlight is ON.

Advantageously, a data-analysis-based control such as disclosed herein facilitates, in one or more embodiments, improved energy harvesting from a roadway using road-based, shadow-effect energy generation. In one or more aspects, the data-analysis-based control facilitates and/or initiates install of a shadow-effect energy generator in one or more optimal road segments to optimize energy harvesting from the road segments using shadow-effect energy generation. Note that although various sub-modules are described, shadow-effect energy harvest control module processing such as disclosed herein can use, or include, additional, fewer, and/or different sub-modules. A particular sub-module can include additional code, including code of other sub-modules, or less code. Further, additional and/or other sub-modules can be used. Many variations are possible.

In one or more embodiments, the sub-modules are used, in accordance with one or more aspects of the present disclosure, to perform shadow-effect energy harvest control processing. FIG. 3 depicts one example of a shadow-effect energy harvest control process, such as disclosed herein. The process is executed, in one or more examples, by a computer (e.g., computer 101 (FIG. 1)), and/or a processor or processing circuitry (e.g., of processor set 110 of FIG. 1). In one example, code or instructions implementing the process, are part of a module, such as shadow-effect energy harvest control module 200. In other examples, the code can be included in one or more other modules and/or in one or more sub-modules of the one or more other modules. Various options are available.

As one example, shadow-effect energy harvest control process 300 executing on a computer (e.g., computer 101 of FIG. 1), a processor (e.g., a processor of processor set 110 of FIG. 1), and/or processing circuitry (e.g., processing circuitry of processor set 110), determines a respective illumination-to-shadow contrast value for each road segment of multiple road segments 302. For instance, in one or more implementations, for each road segment of the multiple road segments, a shadow contour on the road segment is estimated from obtained data, such as geolocation data, time of day data, spectral images of the road and/or structures along the road, satellite image data, video data, light detection and ranging (LIDAR) data, historical traffic data, etc. The estimated shadow contours are then used by the data-analysis-based control in determining respective illumination-to-shadow contrast values.

In one or more embodiments, the shadow-effect energy harvest control process 300 further includes identifying one or more road segments for shadow-effect energy generation 304, where the identifying is based on the respective illumination-to-shadow values. For instance, the identifying can include identifying the one or more road segments with respective illumination-to-shadow contrast values within a specified contrast value range indicative of a desired shadow-effect energy generation potential. In one or more embodiments, shadow-effect energy generation is optimal where the illumination-to-shadow ratio on a shadow-effect energy generator installed as part of the road segment infrastructure is approximately 50%, or within a range about 50% (such as 40% to 60%). Note in this regard that illumination-to-shadow value or ratio is used herein to include both illumination-to-shadow and shadow-to-illumination values or ratios.

In one or more embodiments, the shadow-effect energy harvest control process 300 further includes initiating install of a shadow-effect energy generator in a road segment of the identified one or more road segments to facilitate energy harvesting from the road segment 306. The initiating install can include, for instance, signaling location and dimensions of the road segment or the shadow-effect energy generator to be installed and/or generating install instructions to an installer on dimensions, placement and/or location of the shadow-effect energy generator being installed for optimal energy harvesting.

In one or more embodiments, shadow-effect energy harvest control process 300 further includes training a machine learning model to route or control traffic on the road to enhance road-based, shadow-effect energy generation 308. For instance, depending on the road configuration and adjoining roadway system, the control could, in one embodiment, selectively redirect traffic onto the road using the trained machine learning model to enhance energy generation from the road-based, shadow-effect energy generation using shadows cast by the traffic moving along the road.

In one or more embodiments, shadow-effect energy harvest control process 300 also includes identifying optimal placement for a structure along the side of the road to enhance energy harvesting using the road-based, shadow-effect energy generation 312, and initiating install of the structure based on the identified optimal placement for the structure along the side of the road to enhance energy harvesting using the road-based, shadow-effect energy generation 314. The initiating or facilitating install of the structure can include, for instance, signaling the optimal location for the structure relative to one or more road-based, shadow-effect energy generators installed or to be installed in the road. In one embodiment, the structure can be, or include, a streetlight (such as a conventional streetlight or smart pole with a road light), and the identifying optimizes position of the streetlight relative to one or more installed (or to be installed) road-based, shadow-effect energy generators, for instance, to optimize energy harvesting from the road-based, shadow-effect energy generators at night, when the streetlight is ON.

As indicated initially, solar cell arrays can be used in a variety of applications, such as road infrastructure-based, solar array applications. Existing smart roadway technology use solar panels in road infrastructure to harvest solar energy, but the approach is limited by shadows generated by structures along the side of the road, and/or vehicles moving along the road. Another solar-based technology is shadow-effect energy generation, or shadow-effect energy generator, which uses a contrast between brighter areas and shaded areas on a solar panel to create an electric current.

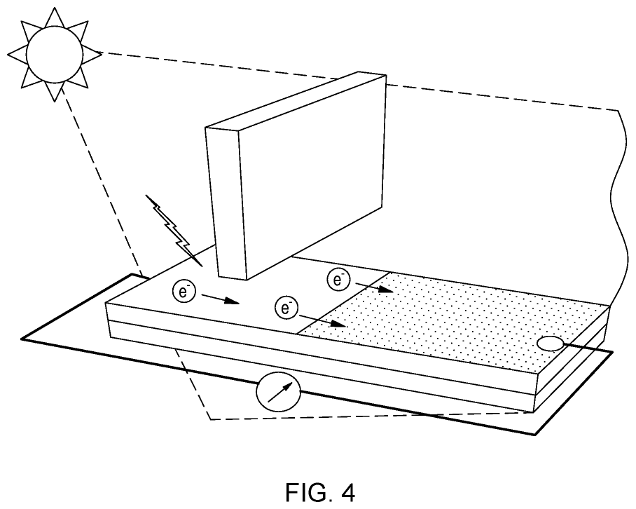

As an example, FIG. 4 schematically illustrates shadow-effect energy generation, where one portion of the shadow-effect energy generator is illuminated by the sun, and another portion is shaded by a structure. Within a shadow-effect energy generator there is a wafer, such as a silicon wafer, with a conductive thin-film, such as a thin, or ultra-thin, gold, aluminum, tungsten, copper, etc., film (or coating). In one or more embodiments, the coating may only be 15 nanometers thick. When light encounters the silicon substrate, photons, or light particles, free electrons, which create direct-current energy flow, for instance, from the illuminated portion of the energy generator to the shaded portion of the energy generator, as illustrated in FIG. 4. In practice, freed electrons move to the thin-film coating, and the metal's voltage increases when there is a difference between the light region and the shaded region of the energy generator.

Generally stated, disclosed herein are computer-implemented methods, computer systems, and computer program products for facilitating energy harvesting, and in particular, for facilitating energy harvesting using road-based, shadow-effect energy generation. For instance, energy harvesting can be improved by leveraging change in shadow contours and illumination contours on different road segments. In one or more embodiments, the frequency of the desired illumination to shadow regions on the road can be controllably increased to facilitate increased power generation per unit of time.

In one or more embodiments, the process includes obtaining a data-analysis-based control to facilitate energy harvesting using road-based, shadow-effect energy generation. The data-analysis-based control includes determining, for multiple road segments of a road, a respective illumination-to-shadow contrast value, and based on the respective illumination-to-shadow values, identifying one or more road segments of the multiple road segments for shadow-effect energy generation. Further, the data-analysis-based control includes initiating install of a shadow-effect energy generator in a road segment of the identified one or more road segments to facilitate energy harvesting from the road segment. For instance, based on two-dimensional and/or three-dimensional spectral image data (such as satellite image data), video data, etc., along the roadway, or with an historical contrast data-based machine learning model, the shadow contour on particular road segments of the road can be estimated or determined for structures along the roadway for a given sun position by extending incidence vectors to the ground, and in particular, to the road. Further, energy generation potential of each road segment can be estimated or determined using the illumination-to-shadow contrast values (or ratios). This estimation process can include accounting for the dynamic nature of shadow contours on the road, for instance, as the day progresses.

In one or more embodiments, the identifying includes identifying the one or more road segments with respective illumination-to-shadow contrast values within a specified contrast value range indicative of a desired shadow-effect energy generation potential. For instance, in one embodiment, the specified contrast value range might be a range of 40% to 60% illumination-to-shadow contrast value or ratio.

In one or more embodiments, the data-analysis-based control further includes determining, for each road segment of the multiple road segments, an energy harvest potential for the road segment using the respective illumination-to-shadow contrast values, where identifying the one or more road segments includes identifying the one or more road segments of the multiple road segments with energy harvest potential above a specified energy harvest potential threshold, e.g., for installation of a shadow-effect energy generator in or at the road segment.

In one or more embodiments, determining the respective illumination-to-shadow contrast values includes estimating, for each road segment of the multiple road segments, a shadow contour on the road segment, and using the estimated shadow contours for the multiple road segments in determining the respective illumination-to-shadow contrast values.

In one embodiment, the identifying includes identifying two or more road segments of the multiple road segments for road-based, shadow-effect energy generation, where at least two road segments of the two or more road segments are adjacent road segments, and the identifying includes aggregating the at least two road segments into an aggregated road segment. The aggregated road segment has an enhanced illumination-to-shadow contrast value in comparison to the respective illumination-to-shadow contrast values of the at least two road segments individually when used for shadow-effect (or shadow-based) energy generation. In such a case, the initiating install includes initiating install of a shadow-effect energy generator spanning, at least in part, the aggregated at least two road segments. This can include, in one or more embodiments, providing geolocation information for the aggregated at least two road segments, and size of the aggregated at least two segments. In this manner, adjacent road segments can be aggregated when a contrast ratio is, for instance, below a certain predefined threshold. The aggregating of road segments can be to maximize overall contrast ratio over two or more segments, and thus, power generation from a respective shadow-effect energy generator. In one implementation, the size of the aggregated road segments (or nodes) determines the configurable size of the shadow-effect energy generator to be installed in the aggregated road segment.

In one or more embodiments, road segments are classified along the road based on the level of shadow-effect power generation capability, with those road segments classified as acceptable being installed with, or configured to harvest energy using, shadow-effect energy generators.

In one or more embodiments, the data-analysis-based control can further include obtaining traffic data for the road, and using the traffic data in determining, for the multiple road segments, the respective illumination-to-shadow contrast values. For instance, in one embodiment, the traffic data can include historical traffic data, along with time of day data, and can be used to determine or estimate anticipated illumination-to-shadow contrast values for the different road segments based, in part, on the traffic moving over the different road segments.

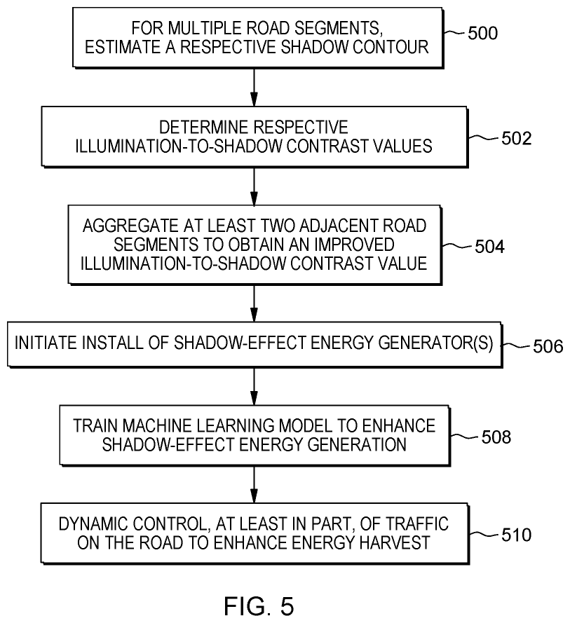

In one embodiment, the data-analysis-based control further includes training a machine learning model to improve road-based, shadow-effect energy generation through routing or control of traffic on the road, and dynamically controlling, at least in part, the traffic on the road using the trained machine learning model to enhance energy generation from the road-based, shadow-effect energy generation. For instance, the data-analysis-based control can include, in one or more aspects, a traffic control facility that analyzes, using the machine learning model, traffic conditions, speed of shadow movement from both static structures and dynamic (or moving) structures (e.g., vehicles) to estimate how much shadow-effect-based power can be recovered, and based thereon, to dynamically control traffic, such as the routing or rerouting of one or more vehicles onto or away from the road over time, and/or to adjust vehicle speed along the road, stop time along the road, etc., so that the shadow-effect energy generation can be increased. FIG. 5 illustrates one embodiment of such a shadow-effect energy harvest control process.

Referring to FIG. 5, for multiple road segments, a respective shadow contour on the road segment is estimated 500. This can be obtained through data analysis of data from various sources, including, for instance, two-dimensional and/or three-dimensional spectral image data, such as from satellite images, video (e.g., closed-circuit television camera data) feeds from various locations along the road, and/or historical learning data, etc. For example, in one embodiment, topographical structures around a road segment are determined using spectral images, and time-series of shadow contours are estimated by extending the solar incident rays to the ground. The time-series of illumination-to-shadow contrast values (proportional to energy) are estimated for the shadow contour for each road segment, which captures shadow contours from static structures along the roadside. In another embodiment, data can be generated from vehicle-mounted cameras, where the vehicle is driven along the road, such as at different times of day, to generate image data from which shadow contours for the different road segments can be determined by the data-analysis-based control.

The shadow-effect energy harvest control process of FIG. 5 further includes determining respective illumination-to-shadow contrast values or ratios 502 with, for instance, an approximate 50% ratio of illumination-to-shade being optimal for shadow-effect power generation. Where beneficial, two or more adjacent road segments are aggregated to obtain an improved illumination-to-shadow contrast value within the aggregated road segment 504. The solar effect energy harvest control process further includes initiating install of the shadow-effect energy generators 506 at selected road segments of the road, such as those road segments where the road segment has a threshold level of shadow-effect-based power generation capability.

As noted, in one or more embodiments, the shadow-effect energy harvest control process can include training a machine learning model to enhance shadow-effect energy generation through control of traffic on the road 508, and dynamically controlling, at least in part, traffic on the road to enhance energy harvesting using the road-based, shadow-effect energy generation 510. For example, for each road segment, the traffic flow data and the respective illumination-to-shadow contrast value are used as a time-series feature to build the machine learning model to predict energy generation capability. In one embodiment, the machine learning model can be integrated with what-if data analysis to, for instance, query for an optimal traffic pattern for routing or rerouting traffic, as well as for placement of roadside structures to increase or maximize energy harvesting using road-based, shadow-effect energy generation.

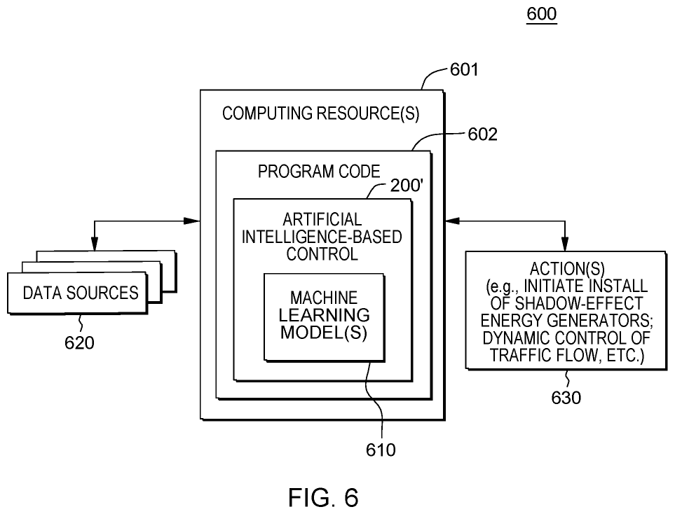

By way of further explanation, FIG. 6 depicts another embodiment of a computing environment or system 600, which can incorporate, or implement, one or more control aspects of an embodiment of the present disclosure. In one or more implementations, system 600 is implemented as part of a computing environment, such as computing environment 100 described above in connection with FIG. 1. System 600 includes one or more computing resources 601 that execute program code 602 that implements, for instance, one or more aspects of a module or facility such as disclosed herein, and which includes an artificial-intelligence-based control 200′, such as shadow-effect energy harvest control module 200 of FIGS. 1 & 2, which can utilize one or more machine learning models 610, such as described herein. Data, such as satellite image data, global positioning system (GPS) data for the road segments, solar irradiance data, sun angle data, structure data for structures along the road, time of day data, and/or other data associated with generating one or more machine learning prediction models to be used in accordance with the present disclosure, is used by a cognitive engine or agent to train machine learning model(s) 610 to (for instance) predict shadow-effect energy generation potential, and to direct initiating install of shadow-effect energy generators, and/or dynamic control of traffic over a road with road-based, shadow-effect energy generation, and/or to control or initiate install of one or more structures along the road, such as one or more light sources, to facilitate nighttime generation of energy from the road-based, shadow-effect energy generators 630, based on the particular application of the machine learning model(s). In one implementation, system 600 can include, or utilize, one or more networks for interfacing various aspects of computing resource(s) 601, as well as one or more data sources 620 providing data, and one or more components, systems, etc., receiving an output, action, etc., 630 of machine learning model(s) 610 to facilitate performance of one or more artificial intelligence system operations. By way of example, the network(s) can be, for instance, a telecommunications network, a local-area network (LAN), a wide-area network (WAN), such as the Internet, or a combination thereof, and can include wired, wireless, fiber-optic connections, etc., operatively coupling the computing resource(s) 601 to the floating solar array and to other data sources. The network(s) can include one or more wired and/or wireless networks that are capable of receiving and transmitting data, including training data for the machine-learning model, and an output solution, recommendation, action, of the machine-learning model(s), such as discussed herein.

In one or more implementations, computing resource(s) 601 house and/or execute program code 602 configured to perform methods in accordance with one or more aspects of the present disclosure. By way of example, computing resource(s) 601 can be a computing-system-implemented resource(s). Further, for illustrative purposes only, computing resource(s) 601 in FIG. 6 is depicted as being a single computing resource. This is a non-limiting example of an implementation. In one or more other implementations, computing resource(s) 601 can, at least in part, be multiple separate computing resources or systems, such as one or more computing resources of a cloud-hosting environment, by way of example only.

Briefly described, in one embodiment, computing resource(s) 601 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed are described further herein with reference to the figures.

In one embodiment, program code 602 executes a cognitive control or agent 200′ which includes (and optionally trains) one or more models 610. The models can be trained using training data that can include a variety of types of data, depending on the model and the data sources. In one or more embodiments, program code 602 executing on one or more computing resources 601 applies one or more algorithms of cognitive control 200′ to generate and train the model(s), which the program code then utilizes to, for instance, to predict shadow-effect energy generation potential, and to direct or initiate install of shadow-effect energy generators, and/or dynamic control of traffic over the road with road-based, shadow-effect energy generation, and/or to control or initiate install of one or more structures along the road, such as one or more light sources, to facilitate (for instance) nighttime generation of energy from road-based, shadow-effect energy generators 630, based on the particular application of the machine learning model(s). In an initialization or learning stage, program code 602 trains one or more machine learning models 610 using obtained training data that can include, in one or more embodiments, one or more data source inputs, including shadow-effect energy generator data, satellite imagery data, weather data, GPS data, time of day data, solar irradiance data, data on structures along the road, vehicle traffic data, etc., such as described herein.

Data used to train the models, in one or more embodiments of the present disclosure, can include a variety of types of data, such as heterogeneous data generated by multiple data sources and/or data stored in one or more databases accessible by, the computing resource(s). Program code, in embodiments of the present disclosure, can perform data analysis to generate data structures, including algorithms utilized by the program code to predict and/or perform an action. As known, machine-learning-based modeling solves problems that cannot be solved by numerical means alone. In one example, program code extracts features/attributes from training data, which can be stored in memory or one or more databases. The extracted features can be utilized to develop a predictor function, h(x), also referred to as a hypothesis, which the program code utilizes as a model. In identifying machine learning model(s) 610, various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weight various attributes (e.g., features, patterns) that correlate to enhanced performance of the model.

In one or more embodiments, program code, executing on one or more processors, utilizes an existing cognitive analysis tool or agent (now known or later developed) to tune the model, based on data obtained from one or more data sources. In one or more embodiments, the program code can interface with application programming interfaces to perform a cognitive analysis of obtained data. Specifically, in one or more embodiments, certain application programing interfaces include a cognitive agent (e.g., learning agent) that includes one or more programs, including, but not limited to, natural language classifiers, a retrieve-and-rank service that can surface the most relevant information from a collection of documents, concepts/visual insights, tradeoff analytics, document conversion, and/or relationship extraction. In an embodiment, one or more programs analyze the data obtained by the program code across various sources utilizing one or more of a natural language classifier, retrieve-and-rank application programming interfaces, and tradeoff analytics application programing interfaces.

In one or more embodiments of the present disclosure, the program code can utilize one or more neural networks to analyze training data and/or collected data to generate an operational machine-learning model 610. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a machine-learning model, such as described herein.

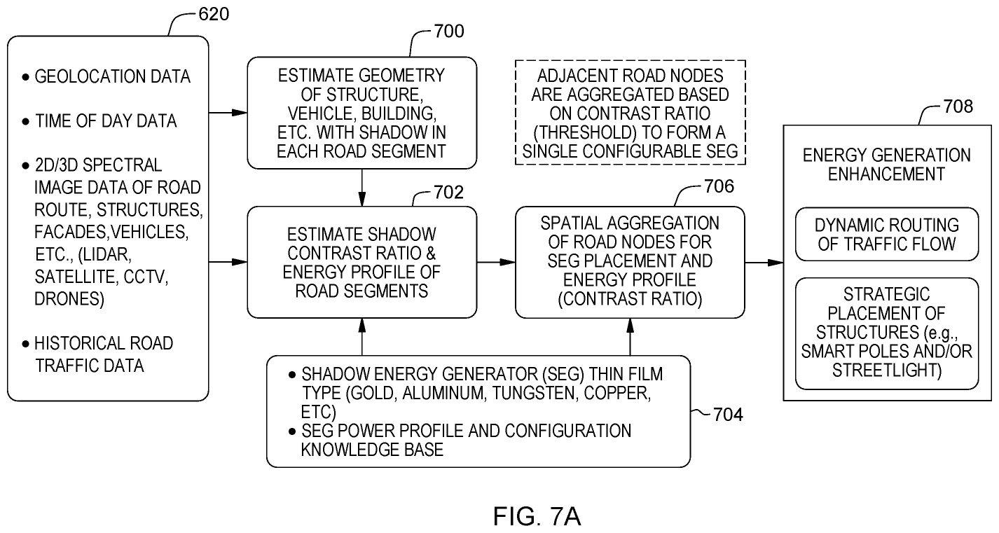

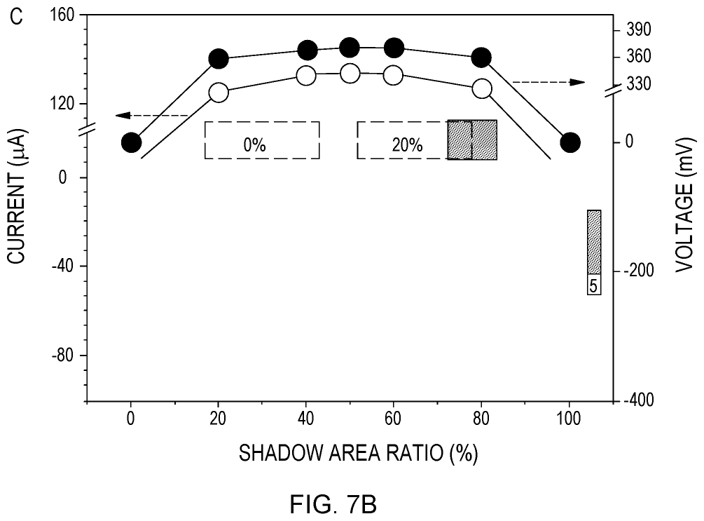

FIG. 7A depicts a further embodiment of a shadow-effect energy harvest control workflow, in accordance with one or more aspects of the present disclosure. In this workflow, data sources 620 provide, for instance, geolocation data on the road, and in particular, the different road segments, time of day data, two-dimensional and/or three-dimensional spectral image data of structures along the road, including static structures (such as buildings, trees, etc.) on the side of the road, and dynamic structures (such as vehicles) moving along the road, etc. Satellite images, LIDAR data and/or video data, such as from CCTV cameras, etc., can be used to generate the image data. Additionally, historical road traffic data for the road and adjacent roads can be obtained, along with other relevant data, including, for instance, solar irradiance data, sun angle data, etc. The shadow-effect energy harvest control, or data-analysis-based control, estimates geometry of a structure, vehicle, etc., with a shadow along the road for each road segment of the road. Note in this regard that the road can be divided into any size road segments desired. In one embodiment, a road segment can be approximately the size of a standard shadow-effect energy generator panel, or standard solar panel (e.g., 3 ft.×5 ft., in one example only). The shadow-effect energy harvest control further determines or estimates from the shadow contours in the different road segments the illumination-to-shadow contrast values, or shadow contrast ratios, and, in one embodiment, determines for each road segment of the multiple road segments, a corresponding energy harvest potential for the road segment using the respective illumination-to-shadow contrast values 702. The shadow-effect energy harvest control can reference, in one embodiment, the particular type of shadow-effect energy generator (SEG) with thin-film (e.g., gold, aluminum, tungsten, copper, etc.), as well as, for instance, the shadow-effect energy power profile and a configuration knowledge base 704.

FIG. 7B depicts one example of a shadow-effect energy generation power profile. Note in this regard that the energy sensitivity of a generator to a shadow-contrast ratio, as well the relative position of a shadow contour and its power generation capability, is generally published by the shadow-effect energy generator manufacturer based on the particular energy generator design, and its embedded thin-film thickness characteristics (e.g., gold, aluminum, tungsten, copper, etc.). A lookup table, such as a three-dimensional lookup table, can be created as a knowledge base for each type of shadow-effect energy generator that might be installed or considered for installation.

As illustrated in FIG. 7A, and noted above, in one or more embodiments, spatial aggregation of road segments or nodes for shadow-effect energy generator placement is performed using, for instance, the energy harvest potential of the different road segments (and in particular, of adjoining road segments), and/or using the illumination-to-shadow contrast values of the different road segments 706. In this manner, adjacent road segments can be aggregated based on the contrast values of the road segments relative to a threshold value to form a larger single, configurable road segment, and thus a larger, single shadow-effect energy generator.

Based on the above, the data-analysis-based control can further make a recommendation and/or take an action to enhance energy harvesting using the road-based, shadow-effect energy generation capability. This can include, for instance, initiating or directing install of shadow-effect energy generators in selected road segments, and dynamically controlling, at least in part, traffic on the road (e.g., using the trained machine learning model(s)), and/or to initiate install of one or more structures (e.g., a streetlight) at identified optimal placement positions along the side of the road, to enhance energy harvesting using the road-based, shadow-effect energy generation.

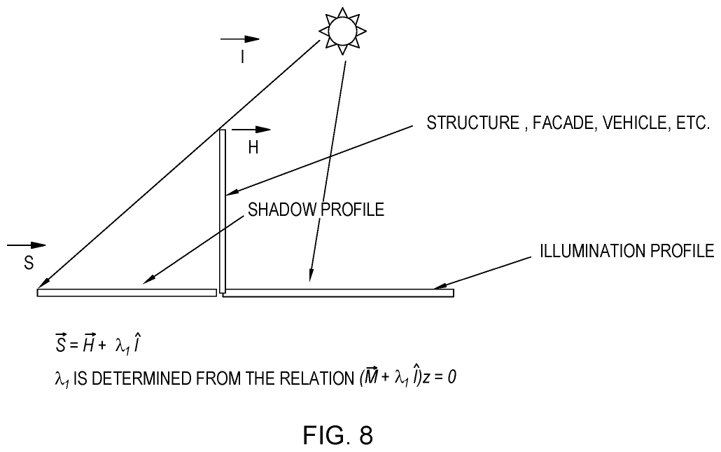

By way of further example, FIG. 8 is a schematic illustrating road-based, shadow-effect energy generation. In this example, a structure (such as a building, sign, tree, vehicle, etc.) creates a shadow area on the road adjacent to an illumination area of the road. From spectral images, the topography and geometry of various structures along the road, and their shadow contours on the road, can be identified, such as described herein. The shadow profile(S) of any structure (H) is obtained by extending the incident vector (1), and finding the coordinates, where the incident vector touches the road-ground plane, where the shadow-effect energy generator can be placed. For each road segment, the ratio of the illumination area and the shadow area in the given area provides the contrast value or ratio. It is directly proportional to the power generation potential, given the shadow-effect energy generation characteristics, that is, the contrast ratio equals the shadow area divided by illumination area, or equals the illumination area divided by the shadow area, depending on the implementation. Note in this regard that the illumination-to-shadow contrast value discussed herein is used to represent either a shadow-to-illumination value or an illumination-to-shadow value.

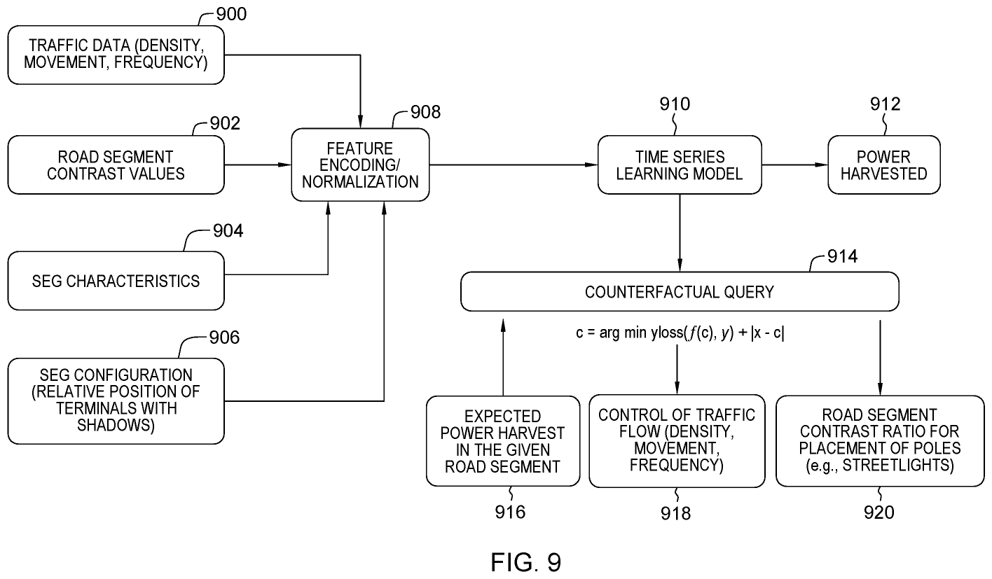

FIG. 9 is a further embodiment of a shadow-effect energy harvest control workflow, in accordance with one or more aspects of the present disclosure. Referring to FIG. 9, the shadow-effect energy harvest control obtains traffic data (e.g., density of traffic, movement of vehicles, frequency of vehicles across the road) 900, as well as road segment contrast values 902 (i.e., illumination-to-shadow contrast values), shadow-effect energy generator characteristics 904, shadow-effect energy generation configuration data 906 (e.g., relative position of generator terminals with shadow contours). The obtained data is used in feature encoding/normalization 908, and fed to a time-series machine learning model 910 to determine the power that can be harvested 912. In the embodiment of FIG. 9, the shadow-effect energy harvest control is configured to make one or more counterfactual queries 914 using the machine learning model and, for instance, expected power harvest in a given road segment 916. Note that in the counterfactual query, x is the obtained data, y is the potential power harvest, and c is the counterfactual output. Using the counterfactual queries, the traffic flow in terms of density, vehicle movement, vehicle frequency 918 can be evaluated, and based on the evaluation, the control can dynamically control, at least in part, traffic on the road to enhance energy generation of the road-based, shadow-effect energy generator(s). Similarly, road segment contrast ratios or contrast values can be used to identify optimal placement for a structure, such a streetlight, along a side of a road to enhance energy harvesting using the road-based, shadow-effect energy generation 920. In one or more further embodiments, adjacent road segments can be aggregated to enhance power generation using road-based, shadow-effect energy generators. In such an approach, the size of a shadow energy generator is configured to the area of the corresponding aggregated segment, and the traffic across the road can be dynamically controlled to, for instance, improve the contrast ratio or contrast value, and thus, the generation of energy. In addition, strategic placement of structures, such as one or more smart poles or streetlights (that emit light at night) can be determined to maximize the contrast ratio of any adjacent road segments effected by the structure to, for instance, optimize energy harvesting from the road-based, shadow-effect energy generation at night when the streetlight is ON.

The terminology used herein is for the purpose of describing particular embodiments only and is not intended to be limiting of the disclosure. As used herein, the singular forms “a”, “and” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating energy harvesting, the computer-implemented method comprising:
obtaining a data-analysis-based control to facilitate energy harvesting using road-based, shadow-effect energy generation, the data-analysis-based control comprising:
determining, for multiple road segments of a road, a respective illumination-to-shadow contrast value;
based on the respective illumination-to-shadow values, identifying one or more road segments of the multiple road segments for shadow-effect energy generation; and
initiating install of a shadow-effect energy generator in a road segment of the identified one or more road segments to facilitate energy harvesting from the road segment.

2. The computer-implemented method of claim 1, wherein the identifying comprises identifying the one or more road segments with respective illumination-to-shadow contrast values within a specified contrast value range indicative of a desired shadow-effect energy generation potential.

3. The computer-implemented method of claim 1, wherein the data-analysis-based control further comprises:
determining, for each road segment of the multiple road segments, an energy harvest potential for the road segment using the respective illumination-to-shadow contrast values; and
wherein the identifying the one or more road segments comprises identifying the one or more road segments of the multiple road segments with energy harvest potential above a specified energy harvest potential threshold.

4. The computer-implemented method of claim 1, wherein determining the respective illumination-to-shadow contrast values includes estimating, for each road segment of the multiple road segments, a shadow contour on the road segment, and using the estimated shadow contours for the multiple road segments in determining the respective illumination-to-shadow contrast values.

5. The computer-implemented method of claim 1, wherein the identifying comprises identifying two or more road segments of the multiple road segments for road-based, shadow-effect energy generation, and wherein at least two road segments of the two or more road segments are adjacent road segments, and the identifying comprises:
aggregating the at least two road segments into an aggregated road segment, the aggregated road segment having an enhanced illumination-to-shadow contrast value in comparison to the respective illumination-to-shadow contrast values of the at least two road segments individually; and
wherein the initiating install includes initiating install of a shadow-effect energy generator spanning, at least in part, the aggregated at least two road segments.

6. The computer-implemented method of claim 1, wherein the data-analysis-based control further comprises:
training a machine learning model to control traffic on the road to enhance the road-based, shadow-effect energy generation; and
dynamically controlling, at least in part, the traffic on the road using the trained machine learning model, the dynamically controlling increasing energy generation from the road-based, shadow-effect energy generation.

7. The computer-implemented method of claim 1, wherein the data-analysis-based control further comprises:
obtaining traffic data for the road; and
using, at least in part, the traffic data in determining for the multiple road segments the respective illumination-to-shadow contrast values.

8. The computer-implemented method of claim 1, wherein the data-analysis-based control further comprises:
identifying an optimal placement for a structure along a side of the road to enhance energy harvesting using the road-based, shadow-effect energy generation; and
initiating install of the structure based on the identified optimal placement for the structure along the side of the road to enhance energy harvesting using the road-based, shadow-effect energy generation.

9. The computer-implemented method of claim 8, wherein the structure comprises a streetlight, and wherein the identifying optimizes position of the streetlight relative to the road-based, shadow-effect energy generation to optimize energy harvesting from the road-based, shadow-effect energy generation at night when the streetlight is ON.

10. A computer system comprising:
a memory; and
at least one processor in communication with the memory, wherein the computer system is configured to perform a method, the method comprising:
obtaining a data-analysis-based control to facilitate energy harvesting using road-based, shadow-effect energy generation, the data-analysis-based control comprising:
determining, for multiple road segments of a road, a respective illumination-to-shadow contrast value;
based on the respective illumination-to-shadow values, identifying one or more road segments of the multiple road segments for shadow-effect energy generation; and
initiating install of a shadow-effect energy generator in a road segment of the identified one or more road segments to facilitate energy harvesting from the road segment.

11. The computer system of claim 10, wherein the data-analysis-based control further comprises:
determining, for each road segment of the multiple road segments, an energy harvest potential for the road segment using the respective illumination-to-shadow contrast values; and
wherein the identifying the one or more road segments comprises identifying the one or more road segments of the multiple road segments with energy harvest potential above a specified energy harvest potential threshold.

12. The computer system of claim 10, wherein the identifying comprises identifying two or more road segments of the multiple road segments for road-based, shadow-effect energy generation, and wherein at least two road segments of the two or more road segments are adjacent road segments, and the identifying comprises:
aggregating the at least two road segments into an aggregated road segment, the aggregated road segment having an enhanced illumination-to-shadow contrast value in comparison to the respective illumination-to-shadow contrast values of the at least two road segments individually; and
wherein the initiating install includes initiating install of a shadow-effect energy generator spanning, at least in part, the aggregated at least two road segments.

13. The computer system of claim 10, wherein the data-analysis-based control further comprises:
training a machine learning model to control traffic on the road to enhance the road-based, shadow-effect energy generation; and
dynamically controlling, at least in part, the traffic on the road using the trained machine learning model, the dynamically controlling increasing energy generation from the road-based, shadow-effect energy generation.

14. The computer system of claim 10, wherein the data-analysis-based control further comprises:
obtaining traffic data for the road; and
using, at least in part, the traffic data in determining for the multiple road segments the respective illumination-to-shadow contrast values.

15. The computer system of claim 10, wherein the data-analysis-based control further comprises:
identifying an optimal placement for a structure along a side of the road to enhance energy harvesting using the road-based, shadow-effect energy generation; and
initiating install of the structure based on the identified optimal placement for the structure along the side of the road to enhance energy harvesting using the road-based, shadow-effect energy generation.

16. The computer system of claim 15, wherein the structure comprises a streetlight, and wherein the identifying optimizes position of the streetlight relative to the road-based, shadow-effect energy generation to optimize energy harvesting from the road-based, shadow-effect energy generation at night when the streetlight is ON.

17. A computer program product comprising:
one or more computer readable storage media and program instructions collectively stored on the one or more computer readable storage media readable by at least one processer to:
obtain a data-analysis-based control to facilitate energy harvesting using road-based, shadow-effect energy generation, the data-analysis-based control comprising:
determining, for multiple road segments of a road, a respective illumination-to-shadow contrast value;
based on the respective illumination-to-shadow values, identifying one or more road segments of the multiple road segments for shadow-effect energy generation; and
initiating install of a shadow-effect energy generator in a road segment of the identified one or more road segments to facilitate energy harvesting from the road segment.

18. The computer program product of claim 17, wherein the identifying comprises identifying two or more road segments of the multiple road segments for road-based, shadow-effect energy generation, and wherein at least two road segments of the two or more road segments are adjacent road segments, and the identifying comprises:
aggregating the at least two road segments into an aggregated road segment, the aggregated road segment having an enhanced illumination-to-shadow contrast value in comparison to the respective illumination-to-shadow contrast values of the at least two road segments individually; and
wherein the initiating install includes initiating install of a shadow-effect energy generator spanning, at least in part, the aggregated at least two road segments.

19. The computer program product of claim 17, wherein the data-analysis-based control further comprises:
training a machine learning model to control traffic on the road to enhance the road-based, shadow-effect energy generation; and
dynamically controlling, at least in part, the traffic on the road using the trained machine learning model, the dynamically controlling increasing energy generation from the road-based, shadow-effect energy generation.

20. The computer program product of claim 17, wherein the data-analysis-based control further comprises:
identifying an optimal placement for a structure along a side of the road to enhance energy harvesting using the road-based, shadow-effect energy generation;
initiating install of the structure based on the identified optimal placement for the structure along the side of the road to enhance energy harvesting using the road-based, shadow-effect energy generation; and
wherein the structure comprises a streetlight, and wherein the identifying optimizes position of the streetlight relative to the road-based, shadow-effect energy generation to optimize energy harvesting from the road-based, shadow-effect energy generation at night when the streetlight is ON.
